(19) United States
(12) Patent Application Publication
(10) Pub. No.: US 2004/0125033 A1
(43) Pub. Date: Jul. 1, 2004

(54) Dual-band antenna having high horizontal sensitivity

(75) Inventor: Dou Yuanzhu, Fukushima-ken (JP)

Correspondence Address: Brinks Hofer Gilson & Lione, P.O. Box 10395, Chicago, IL, 60610, US

(73) Assignee: Alps Electric Co., Ltd.

(21) Appl. No.: 10/737,608

(22) Filed: Dec. 15, 2003

(30) Foreign Application Priority Data
Dec. 16, 2002 (JP) 2002-363923

(51) Int. Cl. H01Q 1/24

(52) U.S. Cl. 343/702

(57) ABSTRACT

A dual-band antenna is described that includes a grounded conductor over a support base; a first radiating conductor plate that is disposed substantially parallel to the grounded conductor; a feeding conductor strip that extends downward from the first radiating conductor plate; a connecting conductor strip for short-circuiting the first radiating conductor plate to the grounded conductor; a second radiating conductor plate that stands vertically to the grounded conductor below the first radiating conductor plate; and a bridge for linking the lower end of the second radiating conductor plate to the lower end of the feeding conductor strip. Supplying high-frequency power having a first frequency to the lower end of the feeding conductor strip causes the first radiating conductor plate to radiate electromagnetic energy at the first frequency; supplying high-frequency power having a second frequency, which is higher than the first frequency, to the lower end of the feeding conductor strip causes the second radiating conductor plate to radiate electromagnetic energy at the second frequency.

This application claims priority to Japanese Patent Application No.: 2002-363923, filed on Dec. 16, 2002, which is incorporated herein by reference.

### BACKGROUND OF THE INVENTION

1. Field of the Invention

The present invention relates to a compact dual-band antenna that can transmit and receive signal waves within two frequency bands and that may be preferably incorporated in an in-vehicle radio communication system or the like.

2. Description of the Related Art

Heretofore, inverted F-shaped antennas have been disclosed as compact dual-band antennas, for example, in Japanese Unexamined Patent Application Publication No. 10-93332 (pages 2 to 3, FIG. 1). Such inverted F-shaped antennas can resonate at two distinct frequencies owing to notches provided in their respective radiating conductor plates.

FIG. 4 is a perspective view of a known inverted F-shaped dual-band antenna 1. The inverted F-shaped dual-band antenna 1 in FIG. 4 has a rectangular notch 4 in a radiating conductor plate 2 to form an L-shaped conductor strip 2a resonating at a first frequency f₁ and a rectangular conductor strip 2b resonating at a second frequency f₂ that is higher than the first frequency f₁. One end of one side of the radiating conductor plate 2 is connected to a connecting conductor strip 3 that stands on a grounded conductor plate 5 for short-circuiting the radiating conductor plate 2 to the grounded conductor plate 5. The entire radiating conductor plate 2 opposes the grounded conductor plate 5 at a predetermined distance (a height of the connecting conductor strip 3). A feed pin 6 is soldered to a predetermined position beneath the radiating conductor plate 2. The feed pin 6 is connected to an antenna circuit (not shown) that is not in contact with the grounded conductor plate 5.

In the known inverted F-shaped dual-band antenna 1 having the structure described above, the length along the extending direction of the L-shaped conductor strip 2a is set to about ¼ of a resonant length λ1 corresponding to the first frequency f₁, and the length along the extending direction of the rectangular conductor strip 2b, which is shorter than the extending direction of the L-shaped conductor strip 2a, is set to about ¼ of a resonant length λ₂ (λ₂<λ1) corresponding to the second frequency f₂. Hence, supplying a predetermined high-frequency power to the radiating conductor plate 2 through the feed pin 6 allows the L-shaped conductor strip 2a and the rectangular conductor strip 2b to resonate at different frequencies, so that signal waves within two frequency bands can be transmitted and received.

In the known inverted F-shaped dual-band antenna 1 in FIG. 4, the directivity of electric waves radiated from the L-shaped conductor strip 2a in the resonance at the first frequency f₁ is shown in FIG. 5A, in which not only upward but also horizontal high gain is achieved. In contrast, the directivity of electric waves radiated from the rectangular conductor strip 2b in the resonance at the second frequency f₂ that is higher than the first frequency f₁ deflects upward as shown in FIG. 5B, such that low gain is achieved horizontally. This is presumably because the direction of a high-frequency current flowing through the rectangular conductor strip 2b is not diversified, unlike a high-frequency current flowing through the L-shaped conductor strip 2a. An in-vehicle communication system has many opportunities to transmit and receive horizontal signal waves, so that the known inverted F-shaped dual-band antenna 1 fails to sufficiently utilize the electric waves at the second frequency f₂. In other words, the known inverted F-shaped dual-band antenna 1 cannot provide a high sensitivity when the horizontal signal waves are transmitted and received at the second frequency f₂.

### SUMMARY OF THE INVENTION

An advantage of the present invention is to provide a dual-band antenna having a high horizontal sensitivity within two frequency bands.

The present invention provides, in its first aspect, a dual-band antenna including a grounded conductor over a support base; a first radiating conductor plate, a feeding conductor strip, a connecting conductor strip, and a second radiating conductor plate. The first radiating conductor plate is disposed substantially parallel to the grounded conductor and resonates at a first frequency. The feeding conductor strip extends downward from the first radiating conductor plate. High-frequency power is supplied to the lower end of the feeding conductor strip. The connecting conductor strip short-circuits the first radiating conductor plate to the grounded conductor. The second radiating conductor plate stands vertically to the grounded conductor below the first radiating conductor plate. The lower end of the second radiating conductor plate is linked to the lower end of the feeding conductor strip and the second radiating conductor plate resonates at a second frequency that is higher than the first frequency. The power may be supplied through a transmission line such as a coaxial cable, or through a coupling network. The support base preferably may be a dielectric material

In the dual-band antenna having the structure described above, high-frequency power is supplied to the lower end of the feeding conductor strip and the lower end of the second radiating conductor plate. Supplying a high-frequency power having the first frequency to the lower end of the feeding conductor strip allows the first radiating conductor plate to serve as an inverted F-shaped antenna, thus achieving a radiation pattern with high horizontal gain. Also, supplying a high-frequency power having the second frequency to the second radiating conductor plate end that is proximate to the ground conductor allows the to second radiating conductor plate serve as a monopole antenna, thus achieving a radiation pattern with high horizontal gain. Accordingly, a high horizontal sensitivity can be realized at two frequencies. Since the upper end of the second radiating conductor plate opposes the first radiating conductor plate, the first radiating conductor plate serves as a capacitive load to the second radiating conductor plate reducing the height of the second radiating conductor plate at resonance and, therefore, it is easy to achieve a low profile of the entire dual-band antenna.

The dual-band antenna preferably-has an arm at the upper end of the second radiating conductor plate that is substantially parallel to the first radiating conductor plate. With this structure, the degree of the capacitive coupling between the first radiating conductor plate and the second radiating conductor plate may be increased to further facilitate the low profile of the entire dual-band antenna. The first radiating conductor plate is preferably linked to the arm of the second radiating conductor plate with a dielectric material further increasing the capacitive loading. With this structure, the first radiating conductor plate is also integrated with the second radiating conductor plate through the dielectric material, thus improving the mechanical strength. Accordingly, is difficult to deform the dual-band antenna even with vibration or shock being applied.

The second radiating conductor plate is preferably provided below the approximate center of the first radiating conductor plate. With this structure, the upward directivity is decreased and the horizontal directivity is increased at the resonance of the second radiating conductor plate 15, thus advantageously improving the horizontal sensitivity.

It is preferable that the first radiating conductor plate, the second radiating conductor plate, the feeding conductor strip, and the connecting conductor strip be formed from a metallic plate. With this structure, pressing the metallic plate can form the dual-band antenna, so that it is possible to avoid a complicated connecting or coupling operation, thus reducing the manufacturing cost and increasing durability and reliability.

The present invention has a number of advantages including the following.

Since the dual-band antenna can cause the first radiating conductor plate to resonate as an inverted F-shaped antenna and can cause the second radiating conductor plate that is vertical to the grounded conductor to resonate as a monopole antenna, a high horizontal sensitivity can be realized in vicinity of resonance at two frequencies. Since the upper end of the second radiating conductor plate opposes the first radiating conductor plate, the first radiating conductor plate serves as a capacitive load in the resonance of the second radiating conductor plate, reducing the height of the second radiating conductor plate. Hence, the low profile of the entire dual-band antenna can be easily achieved.

### BRIEF DESCRIPTION OF THE DRAWINGS

FIG. 1 is a perspective view of a dual-band antenna according to an embodiment of the present invention;

FIG. 2 is a side view of the dual-band antenna;

FIGS. 3A and 3B are characteristic diagrams representing radiation patterns of the dual-band antenna;

FIG. 4 is a perspective view of a known dual-band antenna; and

FIGS. 5A and 5B are characteristic diagrams representing radiation patterns of the known dual-band antenna.

### DESCRIPTION OF THE PREFERRED EMBODIMENTS

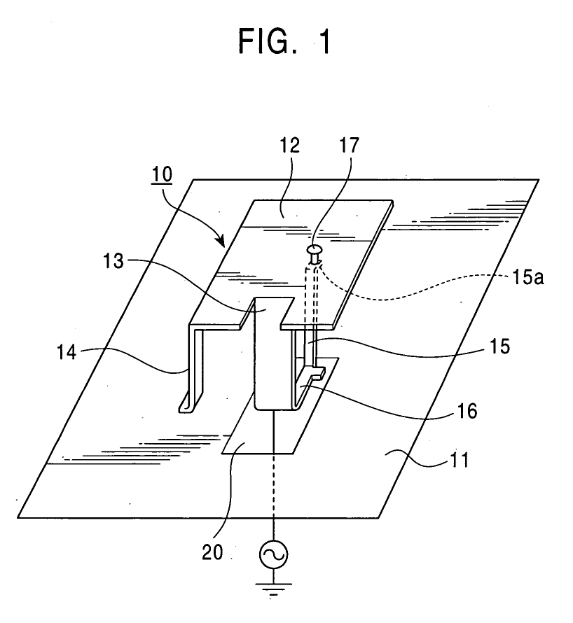

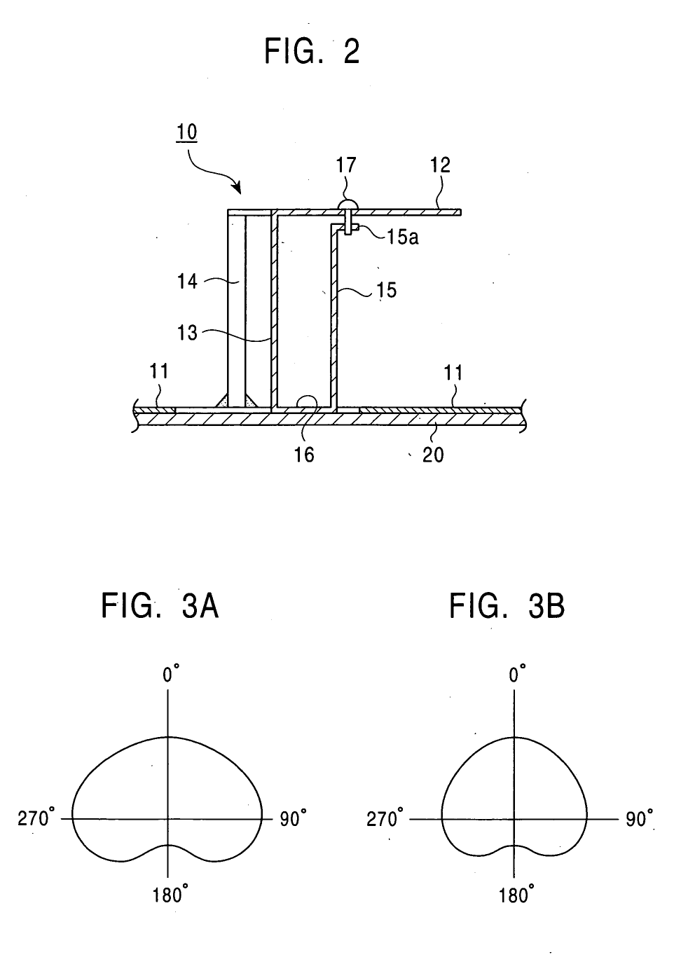

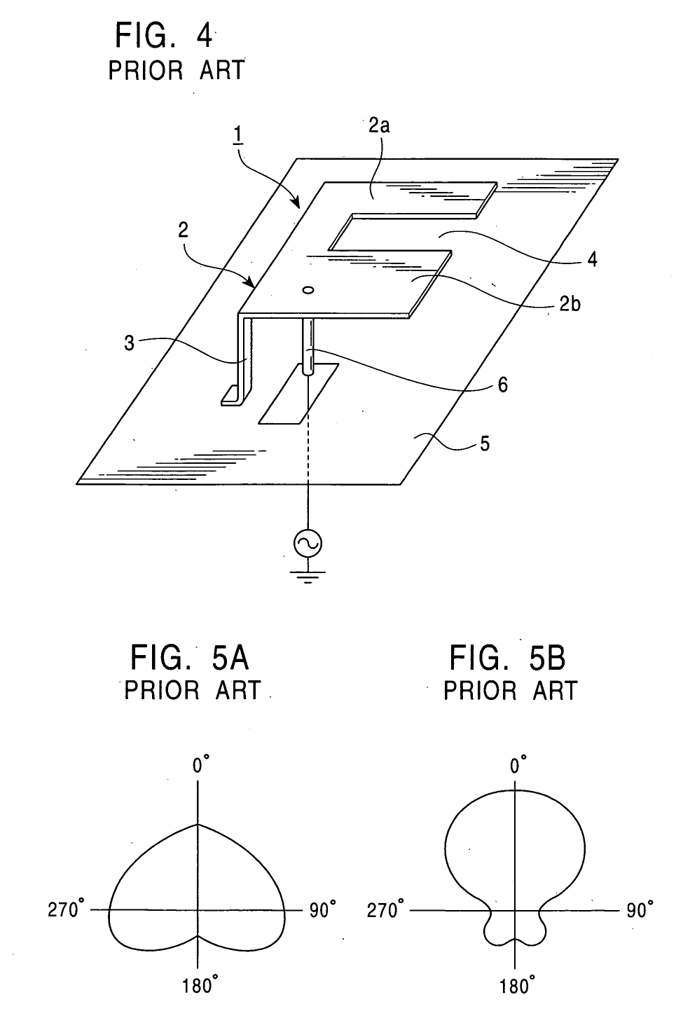

Embodiments of the present invention will now be described with reference to the attached drawings. FIG. 1 is a perspective view of a dual-band antenna according to an embodiment of the present invention. FIG. 2 is a side view of the dual-band antenna. FIGS. 3A and 3B are characteristic diagrams representing radiation patterns of the dual-band antenna.

A dual-band antenna 10 shown in FIGS. 1 and 2 may be formed by pressing a metallic conductor plate (for example, a copper plate) into a certain shape and is mounted on a grounded conductor (ground plane) 11 that is a conductor layer of, for example, copper foil covering almost the entire surface of a support base 20. The dual-band antenna 10 is a compact antenna serving as an inverted F-shaped monopole antenna. The dual-band antenna 10 has a first radiating conductor plate 12, a first feeding conductor strip 13 and a connecting conductor strip 14, a second radiating conductor plate 15, a bridge (second feeding conductor strip) 16, and a dielectric material 17. The first radiating conductor plate 12 is disposed parallel to the grounded conductor 11. The first feeding conductor strip 13 and the connecting conductor strip 14 extend downward from two appropriate positions beneath the first radiating conductor plate 12. The second radiating conductor plate 15 stands below the approximate center of, the first radiating conductor plate 12. The bridge 16 horizontally extends from the lower end of the first feeding conductor strip 13 to the lower end of the second radiating conductor plate 15 to link the first feeding conductor strip 13 to the second radiating conductor plate 15. The dielectric material 17 links the upper end of the second radiating conductor plate 15 to the approximate center of the first radiating conductor plate 12.

A feeder cable (not shown) such as a coaxial cable is connected to the lower end of the first feeding conductor strip 13, so that high-frequency power can be supplied to the first radiating conductor plate 12 through the feeding conductor strip 13 and high-frequency power can also be supplied to the second radiating conductor plate 15 through the bridge 16. Since the lower end of the connecting conductor strip 14 is connected to the grounded conductor 11 although the first feeding conductor strip 13, the bridge 16, and the second radiating conductor plate 15 are not in contact with the grounded conductor 11, the first radiating conductor plate 12 is connected to the grounded conductor 11 through the connecting conductor strip 14. The connecting conductor strip 14 is formed at a position that is optimal for minimizing the impedance missmatch.

The size and shape of the first radiating conductor plate 12 is set so as to resonate upon provision of a high-frequency power having a first frequency f₁ to the first feeding conductor strip 13. The size and shape of the second radiating conductor plate 15 is set so as to resonate upon provision of a high-frequency power having a second frequency f₂ that is higher than the first frequency f₁ to the feeding conductor strip 13. The second radiating conductor plate 15 has an arm 15a at the upper end thereof that is formed substantially parallel to the first radiating conductor plate 12. Since the arm 15a is capacitively coupled to the first radiating conductor plate 12, the first radiating conductor plate 12 serves as a capacitive load in the resonance of the second radiating conductor plate 15 and, therefore, has a similar function to a loading capacitor.

The dual-band antenna 10 having the structure described above causes the first radiating conductor plate 12 to resonate as an inverted F-shaped antenna by providing the high-frequency power having the first frequency f₁ to the first feeding conductor strip 13. Electromagnetic waves radiated from the first radiating conductor plate 12, which resonates at the first frequency f₁, resulting in the radiation pattern shown in FIG. 3A to achieve high horizontal gain. The dual-band antenna 10 also causes the second radiating conductor plate 15 to resonate as a monopole antenna by providing the high-frequency power having the second frequency f₂ to the second radiating conductor plate 15 through the bridge 16. Electromagnetic waves radiated from the second radiating conductor plate 15, which resonates at the second frequency f₂, result in the radiation pattern shown in FIG. 3B so as to also achieve high horizontal gain. Hence, the dual-band antenna 10 provides high horizontal sensitivity in the resonance at two distinct frequencies, thus achieving antenna performance preferable for an in-vehicle communication system.

Since the dual-band antenna 10 has the arm 15a at the upper end of the second radiating conductor plate 15 to capacitively couple the second radiating conductor plate 15 to the first radiating conductor plate 12, the first radiating conductor plate 12 serves as the capacitive load to decrease the resonant frequency of the second radiating conductor plate 15 and to reduce the electrical length of the second radiating conductor plate 15 necessary for the resonance at a predetermined frequency. In other words, it the second radiating conductor plate 15, which resonates at a frequency f₂ which is grater that f₁ and is capacitively coupled to the first radiating conductor plate 12, has a smaller height and, therefore, the second radiating conductor plate 15 does not compromise the low profile of the entire dual-band antenna 10. With the upper end (the arm 15a) of the second radiating conductor plate 15 opposing the approximate center of the first radiating conductor plate 12, as in this embodiment, the upward directivity decreases and the horizontal directivity increases at the resonance of the second radiating conductor plate 15, thus advantageously improving the horizontal sensitivity.

In the dual-band antenna 10, the arm 15a of the second radiating conductor plate 15 is linked to the first radiating conductor plate 12 with the dielectric material 17, so that the first radiating conductor plate 12 is integrated with the second radiating conductor plate 15 to improve the mechanical strength. Accordingly, the dual-band antenna 10 is difficult to deform even with vibration or shock being applied when it is incorporated in the in-vehicle communication system and, therefore, achieves stable performance for a long period of time.

Since the first radiating conductor plate 12, the second radiating conductor plate 15, the first feeding conductor strip 13, and the connecting conductor strip 14 and the second feeding conductor strip 16 of the dual-band antenna 10 can be collectively formed from a single metal sheet, a complicated connecting or coupling operation can be omitted. Hence, the dual-band antenna 10 can be advantageously manufactured at a low cost.

What is claimed is:

1. A dual-band antenna, comprising:
a grounded conductor disposed over a support base;
a first radiating conductor plate that is disposed substantially parallel to the grounded conductor;
a first feeding conductor strip extending downward from the first radiating conductor plate;
a connecting conductor strip for connecting the first radiating conductor plate to the grounded conductor; and
a second radiating conductor plate oriented orthogonally to the grounded conductor and disposed between the grounded conductor and the first conductive radiating plate,
wherein a lower end of the second radiating conductor plate is linked to a grounded conductor end of the first feeding conductor strip by a second feeding conductor strip.

2. The dual-band antenna according to claim 1, further comprising an arm formed at an upper end of the second radiating conductor plate, the arm being substantially parallel to the first radiating conductor plate.

3. The dual-band antenna according to claim 2, further comprising a dielectric material for coupling the first radiating conductor plate to the arm.

4. The dual-band antenna according to claim 1, wherein the second radiating conductor plate is disposed below an approximate center of the first radiating conductor plate.

5. The dual-band antenna according to claim 1, wherein the first radiating conductor plate, the second radiating conductor plate, the first feeding conductor strip, the second feeding conductor strip and the connecting conductor strip are integrally formed from a metallic plate.

6. A dual-band antenna, comprising:
a ground plane;
a first radiating conductor plate disposed substantially parallel to the ground plane;
a connecting conductor strip connecting the first radiating conductor to the ground plane;
a first feeding conductor strip extending from near a plane of the ground plane to the first radiating conductor plate;
a second radiating conductor plate disposed between the first radiating conductor plate and the ground plane; and
a second feeding conductor strip extending from a ground plane end of the first feeding conductor strip to a ground plane end of a second radiating conductor plate,
wherein the second radiating conductor plate is substantially perpendicular to the ground plane and has a length that is shorter than a distance between the first radiating conductor plate and the ground plane.

7. The dual-band antenna in accordance with claim 6, wherein the ground plane end of the first feeding conductor strip is adapted to connect to a radio transmission line.

8. The dual-band antenna in accordance with claim 6, wherein the first radiating conductor plate radiates at a first frequency and the second radiating conductor plate radiates at a second frequency.

9. The dual-band antenna in accordance with claim 8, wherein the second frequency is greater than the first frequency.

10. The dual-band antenna in accordance with claim 6, wherein a slot is provided in the first radiating conductor plate disposed between the feeding conductor strip and a proximal end of the first radiating conductor plate.

11. The dual-band antenna in accordance with claim 6, wherein the connecting conductor strip extends from a side of the first radiating conductor plate proximal to a corner thereof to the ground plane.

12. The dual-band antenna in accordance with claim 11, wherein the connecting conductor strip is soldered to the ground plane.

13. The dual-band antenna according to claim 6, further comprising an arm formed at an upper end of the second radiating conductor plate, the arm being substantially parallel to the first radiating conductor plate.

14. The dual-band antenna according to claim 13, further comprising a dielectric material disposed between the first radiating conductor plate and the arm.

15. The dual-band antenna in accordance with claim 14, wherein the first radiating conductor plate is connected to the arm by the dielectric material.

16. The dual-band antenna according to claim 13, wherein linear dimensions of the arm are variable to adjust a capacitive loading of the second radiating conductor plate by the first radiating conductor plate.

17. The dual-band antenna in accordance with claim 8, wherein locations of the first feeding conductor strip, the second radiating conductor plate and the connecting conductor strip are adjustable to achieve a desired voltage standing wave ratio at each of the first frequency and the second frequency.

18. The dual-band antenna in accordance with claim 6, wherein radio frequency energy is coupled from a center conductor of a coaxial transmission line to a ground plane end of the first feeding conductor strip and a shield of the coaxial transmission line is connected to the ground plane.

19. A dual-band antenna, comprising:
a dielectric material substrate;
a ground plane having an aperture formed therein and disposed on the substrate;
a first radiating conductor plate disposed substantially parallel to the ground plane;
a connecting conductor strip connecting the first radiating conductor plate to the ground plane;
a first feeding conductor strip extending from the aperture in the ground plane to the first radiating conductor plate;
a second radiating conductor plate oriented orthogonal to the substrate; and
a second feeding conductor strip extending from a ground plane end of the first feeding conductor strip to a ground plane end of the second radiating conductor plate,
wherein the first feeding conductor strip, the second feeding conductor strip and the second radiating conductor plate are disposed over the aperture.

20. A radio communications apparatus including a dual-band antenna in accordance with claim 1.

21. A dual-band antenna having a first radiating conductor plate and a ground plane, comprising:
means for supporting the ground plane;
means for radiating electromagnetic energy disposed between the ground plane and the first radiating conductor plate;
means for connecting the first radiating conductor plate to the ground plane; and
means for connecting a source of electromagnetic energy to the first radiating conductor plate and the means for radiating electromagnetic energy.

22. A method of radiating two frequencies, comprising;
providing a conducting ground plane;
providing a first radiating conductor plate;
providing a second radiating conductor plate, located between the conducting ground plane and the first radiating conductor plate;
connecting the first radiating conductor plate to the conducting ground plane with a conductive connection strip; and
feeding radio frequency energy to a conducting ground plane end of the second radiating conductor plate and to the first radiating conductor plate.

23. The method of claim 22, further comprising providing an arm at an end of the second radiating conductor plate more distal to the conducting ground plane, the arm being oriented approximately parallel to the first radiating conductor plate.

24. The method of claim 23, further comprising disposing a dielectric material between the arm and the first radiating conductor plate.

25. The method of claim 24, further comprising connecting the first radiating conductor plate and the arm using the dielectric material.
